(19) United States
(12) Patent Application Publication
(10) Pub. No.: US 2026/0278002 A1
(43) Pub. Date: Sep. 17, 2026

(54) ASSET STORAGE AND RETRIEVAL USING WORD PERMUTATIONS

(71) Applicant: Disney Enterprises, Inc., Burbank, CA (US)

(72) Inventors: Matthew Robert Walters, Los Angeles, CA (US); Matthew Steele Lathrop, Dallas, TX (US); Kelsey McCullough, Los Angeles, CA (US); Stephanie Perea, Los Angeles, CA (US)

(73) Assignee: Disney Enterprises, Inc., Burbank, CA (US)

(21) Appl. No.: 19/076,483

(22) Filed: Mar. 11, 2025

(51) Int. Cl. G06F 16/22

(52) U.S. Cl. CPC G06F 16/9014; G06F 16/2291

(57) ABSTRACT

In some embodiments, a method receives a request for a first asset. The request includes a word permutation. The method determines whether the first asset can be retrieved from a database using the word permutation. Responsive to determining the first asset cannot be retrieved, the method determines a second asset representation for a second asset that is within a threshold to a first asset representation in a space. The asset representations are encoded into the space based on contents of respective assets. Also, the method returns the second asset for the request. Responsive to determining the first asset cannot be retrieved: the method retrieves the first asset from the database and returns the first asset for the request.

### BACKGROUND

Digital asset management has witnessed significant growth as organizations increasingly rely on vast repositories of digital content to drive their operations. However, effectively managing these assets poses substantial challenges, particularly in managing specific files across multiple different systems. Traditional solutions often employ technical identifiers, such as hashes (e.g., SHA256), to uniquely identify files. While robust for machine-to-machine interactions, these identifiers are cumbersome for human communication due to their length and complexity. For instance, a SHA256 hash appears as an unintelligible string (e.g., c27cale58418a8cc8169f2f36c38969cdfcac0d3ab0eab7659ca74c99518fb09), which hinders file identification and collaboration.

Other problems may also exist in digital asset management systems. Identifying assets between systems may be difficult. The same exact file may be stored in multiple systems, but under a different file names or identifiers. Often, a system may use hashes of files to compare files to determine if they are the same. However, trying to search for an asset by its hash is difficult due to the length and complexity of the string. Additionally, searching by the hash provides no opportunity to find similar assets. For example, the hash of the same frame of video in two different file formats will be radically different. Thus, the system could not identify the two files using the hash of one of the files.

### BRIEF DESCRIPTION OF THE DRAWINGS

The included drawings are for illustrative purposes and serve only to provide examples of possible structures and operations for the disclosed inventive systems, apparatus, methods, and computer program products. These drawings in no way limit any changes in form and detail that may be made by one skilled in the art without departing from the spirit and scope of the disclosed implementations.

FIG. 1 depicts a simplified system for managing assets according to some embodiments.

FIG. 2 depicts a simplified flowchart for storing assets according to some embodiments.

FIG. 3 depicts a table that shows a mapping of asset identifiers, word permutations, word permutation identifiers, and asset representations according to some embodiments.

FIG. 4 depicts a simplified flowchart for retrieving assets according to some embodiments.

FIG. 5 depicts a simplified flowchart of a method for generating word permutations according to some embodiments.

FIG. 6 illustrates one example of a computing device according to some embodiments.

### DETAILED DESCRIPTION

Described herein are techniques for a storage system. In the following description, for purposes of explanation, numerous examples and specific details are set forth to provide a thorough understanding of some embodiments. Some embodiments as defined by the claims may include some or all the features in these examples alone or in combination with other features described below, and may further include modifications and equivalents of the features and concepts described herein.

### System Overview

A system may assign a word permutation, such as a combination of three to five words, to respective assets that may serve as the universal identifier for the respective assets. The system may map the word permutation to the asset, such as to an identifier (e.g., a hash) of the asset file itself. When a client device wants to retrieve an asset, the client device may send the word permutation to the system. The system may use the word permutation to retrieve the asset. For example, the system may look up the asset's identifier, such as the asset's hash. Then, the system may use the identifier to retrieve the asset from storage, and return the asset to the client device. For example, the database may maintain an index of hashes to storage locations for assets, which is used to retrieve the asset from the storage location.

The system may also generate a representation of assets, such as an embedding, in a space. The embedding may represent the content of the asset. Assets with similar content may have associated representations that are closer in the space. When the system looks for an asset and cannot return an asset matching the specific asset hash identifier, the system may use the representations in the space to determine a similar asset. For example, an embedding in the space that is similar to the requested asset may be determined. In some examples, if the same frame is stored in two different file formats, such as Portable Network Graphics (PNG) and open EXR (EXR), the hashes of these two assets may be different because a hash algorithm may be extremely sensitive to changes where any difference in the two files may result in vastly different hash values. However, the embeddings are designed to smooth over small changes, making similar inputs map to nearby embeddings in the space. Thus, the embeddings may not be identical, but may be very close together in the space. The system may not have the requested PNG version, and could find the PNG version, but returns the EXR version instead.

Accordingly, using word permutations may improve the storage of assets. For example, the word permutations may be used to request the assets, where the word permutations can be identified more clearly compared to a hash of the asset. This may reduce the mistakes in retrieving files. Also, the storage efficiency may be improved. For example, using a word permutation, such as a three word permutation may require less bits than a hash of a standard size, such as a standard SHA256 hash. For example, SHA256 requires hashes to be 256 bits but less bits may be used by limiting the pool of words in which the three word identifier can be selected. For example, all three word permutations of a 6000 word pool could be represented by 38 bits (e.g., ceiling(log2(P(6000,3)))=38), such as the words may be compressed to a hash of 38 bits. Also, using the representations in the space, the retrieval may be more robust because the system can determine other assets that may be similar to an asset that cannot be retrieved. Additionally, the representations may be used to identify duplications or near duplications that are being stored, and the duplications may be deleted.

### System

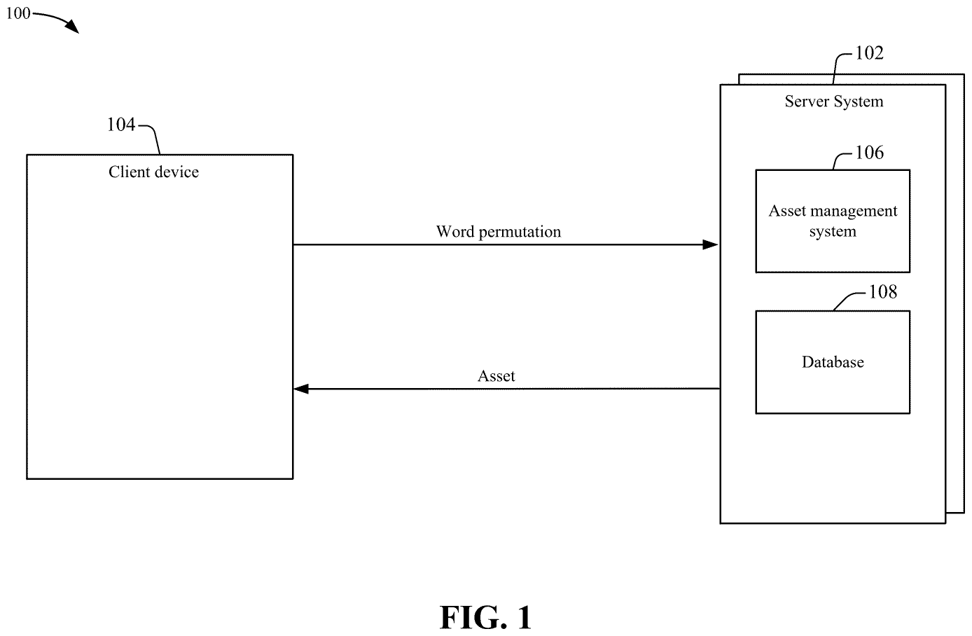

FIG. 1 depicts a simplified system 100 for managing assets according to some embodiments. System 100 includes a server system 102 and a client device 104. Server system 102 may include multiple different systems that manage assets. For example, the systems may have their respective databases that store assets independently. Also, each system may store different assets. In some embodiments, a request to one system may be processed based on the respective assets stored by that system and not based on assets stored by other systems.

Client device 104 may be a computing device that requests assets from server system 102. For example, client device 102 may request an asset from server system 102, and receive an asset that is retrieved from database 108.

Server system 102 includes an asset management system 106. Asset management system 106 may organize, track, and manage assets. For example, asset management system 106 may store assets in database 108, and allow retrieval of those assets. An asset may be information that can be retrieved from server system 102. In some embodiments, an asset may be a unit of storage, such as files, records, metadata, audio, video, etc.

Asset management system 106 may maintain identifying information for the assets to allow the assets to be retrieved. As will be discussed in more detail below, asset management system 106 allows client device 104 to send a word permutation to retrieve an asset. Then, asset management system 106 uses the word permutation to retrieve the asset from database 108, and return the asset to client device 104. A word permutation may be a series of words that are combined and serve as the asset's universal identifier, which may be used across multiple different server systems and database systems. An example of a three-word permutation may be red, blue, green. However, other combinations may be used, such as a five-word combination. Three to five word combinations may be more easily recalled, such as a three word combination may be easier to recall compared to a hash of an asset.

Different assets may be identified by different word permutations. In some embodiments, the words in the word permutation may be chosen from a list of words, such as a predetermined list of words. The predetermined number of words may be used to guarantee there are enough permutations to cover the assets that are being stored in database 108. The words that may be predetermined may be easy to communicate words so that it is clear when communicating (e.g., verbally or written) the word permutation, mistakes may not be made. For example, the words “to”, “too”, and “two” may be words that are avoided since they sound the same and can be confused. The word permutation may be a number of words such that the human brain can remember the words, such as three words. The number of words may be increased, such as expanded to five words. Expanding the number of words may increase the number of permutations such that there may not be collisions if words permutations are generated for multiple assets. Then, word permutations may be randomly generated without worrying about collisions.

Using the word permutations may improve the storage of assets. For example, the use of the permutations words is scalable depending on the asset management system requirements. Also, the word permutations may improve the readability of the identifiers. For example, word permutations may be easier to include and request compared to hash identifiers which are a very complicated series of numbers and letters. This may reduce mistakes when identifying files and allow assets to be correctly identified. The storage of the word permutations may also be efficient due to the inclusion of words in the word permutation, which can also be reduced to a compressed identifier, such as a hash of the three words.

The following will now describe an asset storage process in more detail, and then the asset retrieval process will be described.

### Storage Process

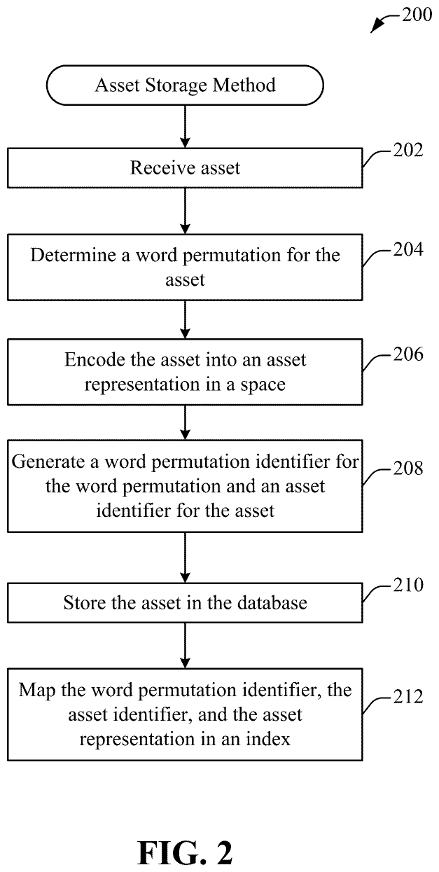

FIG. 2 depicts a simplified flowchart 200 for storing assets according to some embodiments. At 202, asset management system 106 receives an asset. For example, the asset may be a file. In some embodiments, the file stores one or more frames of a video. However, other types of files may also be received.

At 204, asset management system 106 determines a word permutation for the asset. In some embodiments, asset management system 106 may strategically determine the word permutation. As will be discussed in more detail below, assets may be encoded to a space, such as a higher dimensional embedding space compared to the input space. Word permutations for assets that are closer in the space may have similar word permutations generated. For example, two similar assets may have similar word permutations generated of “red, green, blue”, and “red, green, purple”. In other embodiments, the word permutation may be randomly generated, or generated without context to the content of the assets.

At 206, asset management system 106 encodes the asset into an asset representation in a space. An encoder may use an algorithm to encode the contents of the asset into an asset representation. For example, the asset representation may be a vector embedding of a number of dimensions in the space. The embedding space may be a higher dimensional space where the embeddings represent the content of an asset. The embeddings capture patterns or semantics of the input. Small changes in the input often result in slight shifts in the embedding, maintaining similarity in the space. In contrast, hashes of the same files may be vastly different and cannot be used to determine similarity of the two files.

At 208, asset management system 106 may generate a word permutation identifier for the word permutation and an asset identifier for the asset. The word permutation identifier may be generated using an algorithm that is different from the algorithm used to generate representations in the space, such as using a hash of the word permutation. In some embodiments, the generation of the word permutation identifier may be optional. However, the word permutation identifier may be a more compact way of storing the word permutation. The asset identifier may also be a hash of the asset. For example, the asset identifier may be a hash of the content of the asset. A hash may use an algorithm, such as SHA-256, that generates the asset hash based solely on the asset's contents.

At 210, asset management system 106 stores the asset in database 108. For example, the asset is stored in a location in the database 108. Asset management system 106 may map the location of the asset to the asset identifier, such as in an index.

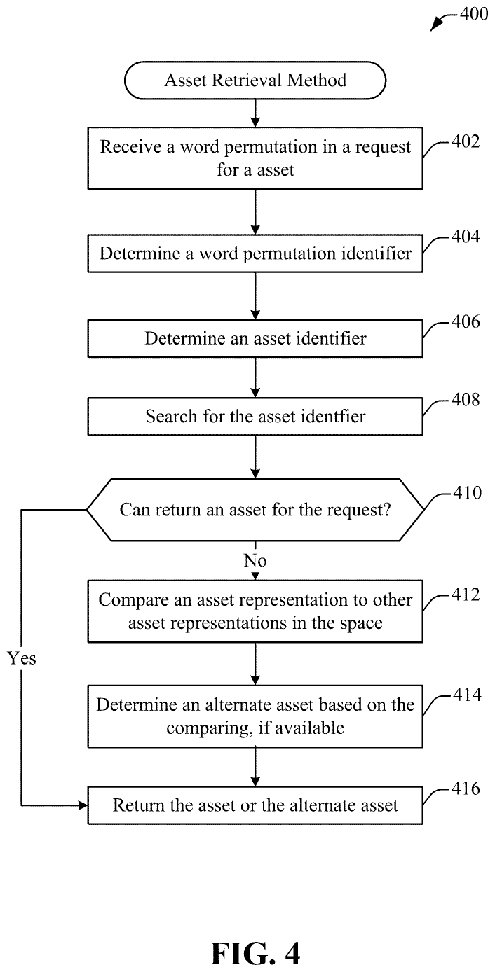

At 212, asset management system 106 maps the word permutation identifier, the asset identifier, and the asset representation in a data structure, such as a table, key value store backed by a hash table, or other structures. A table may be used for discussion purposes. This mapping allows asset management system 106 to use the word permutation to retrieve the asset in the database 108, the process of which will be described in more detail at least in FIG. 4.

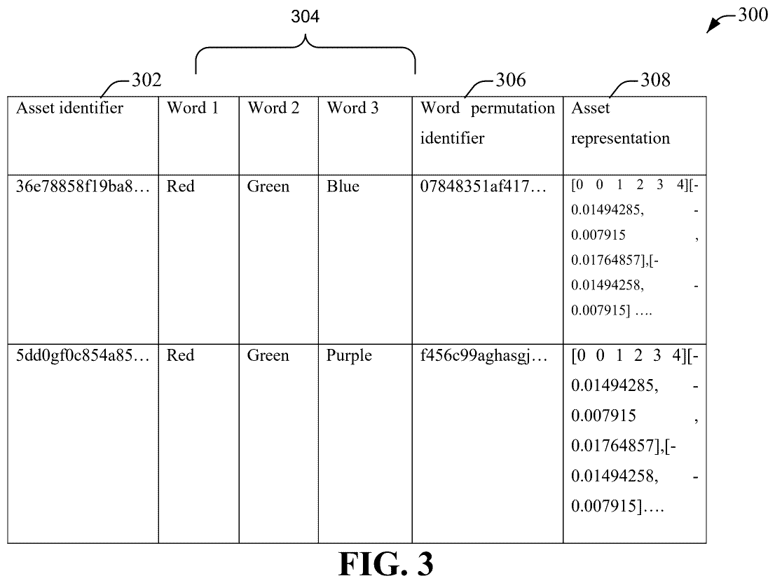

FIG. 3 depicts a table 300 that shows a mapping of asset identifiers, word permutations, word permutation identifiers, and asset representations according to some embodiments. In table 300, a column 302 lists the asset identifier. The asset identifier may be a hash of the asset or another type of identifier. Columns 304 list the word permutation, such as a word 1, a word 2, and a word 3. A column 306 lists the word permutation identifier. For example, the word permutation identifier may be a hash of the three words, or another type of identifier. A column 308 lists an asset representation in a space. For example, an encoder may encode the contents of the asset into a representation in the space, such as a vector representation. Here, values for multiple dimensions are shown for the asset in a vector format. Each dimension may include a numeric value in brackets. In some embodiments, some columns of table 300 may not be included. For example, the word permutation of words at 304 may not be included.

Table 300 may be used to respond to a request. For example, asset management system 106 receives a word permutation. Then, asset management system 106 determines a word permutation identifier for the word permutation. A row in table 300 is determined that matches the word permutation identifier. The row contains the asset identifier, which can be used to retrieve the asset from database 108. Also, the row includes the asset representation, which can be used to retrieve similar assets. For example, the asset representations are similar, such as the asset representations start with the same values in the vector representation for the two asset identifiers. There may be some small differences at the end of the asset representation. These processes will be described in more detail now.

### Asset Retrieval

FIG. 4 depicts a simplified flowchart 400 for retrieving assets according to some embodiments. At 402, asset management system 106 receives a word permutation in a request for an asset. For example, client device 104 may send a word permutation of “red, green, blue” in a request.

At 404, asset management system 106 determines a word permutation identifier. For example, asset management system 106 may generate the word permutation identifier based on the words, which may be a hash of the word permutation.

At 406, asset management system 106 determines an asset identifier for the asset. For example, asset management system 106 may look up the asset identifier based on the word permutation identifier in table 300. The asset identifier may be a hash of the contents of the asset.

At 408, asset management system 106 searches for the asset that is associated with the asset identifier in database 108. For example, different systems may store different assets. Table 300 may be provided to multiple systems to allow mappings to be performed. Database 108 may maintain an index of asset identifiers to storage locations for assets. Asset management system 106 determines if the asset corresponding to the asset identifier is stored in database 108 and assessable to it using the asset identifier. For example, an asset may be available if it is indexed by the asset identifier and may not be available if the asset identifier does not exist in the index. Other methods for determining whether the asset is stored in database 108 may be used.

At 410, asset management system 106 determines if it can return an asset for the request. For example, an asset may be returned if it is found in database 108. However, there may be also other reasons why an asset cannot be returned, such as file permissions may be set to not allow the client device 104 to receive the asset.

Responsive to asset management system 106 determining it cannot return the asset, at 412, asset management system 106 compares an asset representation for the asset to other asset representations in the space. For example, asset management system 106 retrieves the asset representation for the asset in table 300 using the word permutation identifier. Then, the value for the asset representation may be compared to other asset representations in the space. For example, a threshold may be used to determine other asset representations that are within a distance to the asset representation for the asset. In some examples, the asset representation may be found for another asset that has similar content to the asset representation for the requested asset of red, green, blue.

At 414, asset management system 106 determines an alternate asset based on the comparing, if available. For example, if an asset representation for an alternate asset meets the threshold, then asset management system 106 may select that alternate asset. In some embodiments, asset management system 106 determines an asset representation based on a condition, such as distance. For example, the asset representation may be the closest in distance to the asset representation for the word permutation (while meeting a threshold). In other embodiments, if there are multiple asset representations that meet a threshold, then asset management system 106 may rank the asset representations (e.g., by distance or another metric) and return one or more of the top ranked alternate assets, return all the alternate assets, or select alternate assets in other ways.

At 416, asset management system 106 returns the asset that was requested in response to determining it can return the asset, or asset management system 106 returns the alternate asset. For example, at 410, if an asset can be returned for the request, then the asset management system 106 returns that asset. However, if an alternate asset is determined at 414, asset management system 106 returns the alternate asset.

Accordingly, asset management system 106 uses word permutations to retrieve asset efficiently. The word permutation may be easy to communicate in a request. Then, asset management system 106 may use identifiers to retrieve the asset, or representations in a space to determine an alternate asset.

Word permutations may be generated to be related to the asset representations in the space. This may allow word permutations for similar assets to be similar. The following will describe the generation in more detail.

### Word Permutation Generation

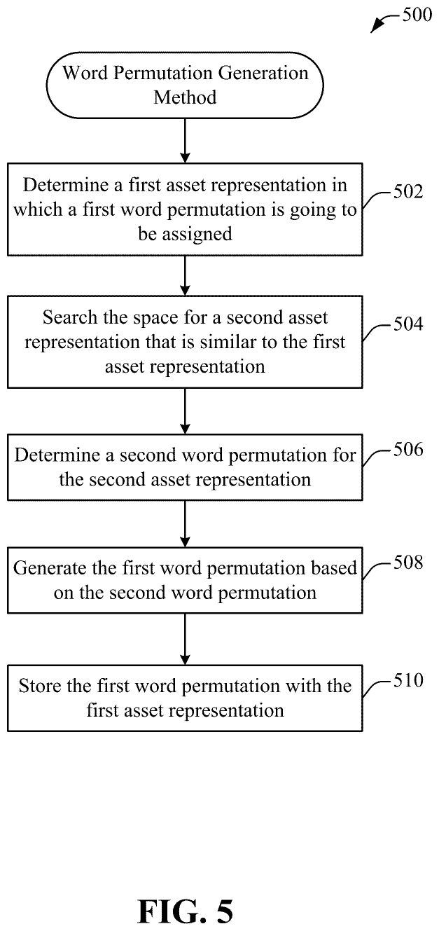

FIG. 5 depicts a simplified flowchart 500 of a method for generating word permutations according to some embodiments. The following method may be used to generate word permutations, but other methods may be used. Further, a combination of methods may be used, such as some assets may have their word permutations generated randomly, and some assets that are similar may have their word permutations generated using this process while other assets that are not similar have their word permutations generated randomly.

At 502, asset management system 106 determines a first asset representation in which a first word permutation is going to be assigned. For example, the first asset representation may be an embedding in the space for a first asset.

At 504, document management system 106 searches the space for a second asset representation that is similar to the first asset representation. For example, a threshold may be used to determine second asset representations that are within a threshold distance to the first asset representation. One or more second asset representations may be retrieved.

At 506, asset management system 106 determines a second word permutation for the second asset representation. For example, the second asset representation may already be associated with a previously generated second word permutation because the second asset is already stored in database 108. For example, the second word permutation may be “red, green, blue”.

At 508, document management system 106 generates the first word permutation based on the second word permutation. For example, a word permutation that is similar to the second word permutation may be generated, such as “red, green, purple”. Different methods may be used to generate a similar word permutation. For example, document management system 106 may use encoding models to determine semantically similar word permutations. Also, document management system 106 may attempt to keep some words to be the same, such as try to keep two words the same for similar assets and just change the third word. Here, “red, green, purple” may be more similar compared to “car, house, door” because colors are still used and two of the colors are the same.

At 510, asset management system 106 stores the first word permutation with the first asset representation. Accordingly, the first asset is associated with a first word permutation that is similar to the second word permutation. This may provide more context as to which word permutations are associated with similar assets. Also, the two word permutations may be stored near each other in the database, which may increase the speed and efficiency of retrieval, such as resulting in fewer cache misses.

### Conclusion

Accordingly, using word permutations may improve the storage of assets. For example, the word permutations may be used to request the assets, where the word permutations can be identified more clearly compared to a hash of the asset. This may reduce the mistakes in retrieving files. Also, using the asset representations in the space, asset management system 106 can determine alternate files that may be similar to an asset that may not be able to be retrieved. Also, the generation of the word permutations may utilize the space to generate similar word permutations.

### System

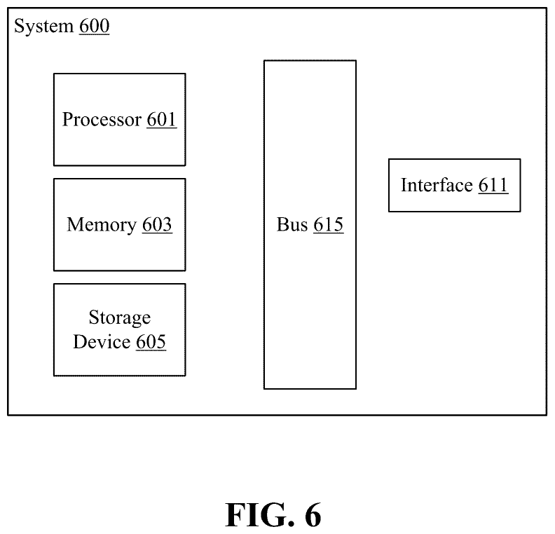

FIG. 6 illustrates one example of a computing device according to some embodiments. According to various embodiments, a system 600 suitable for implementing embodiments described herein includes a processor 601, a memory 603, a storage device 605, an interface 611, and a bus 615 (e.g., a PCI bus or other interconnection fabric.) System 600 may operate as a variety of devices such as server system 102, or any other device or service described herein. Although a particular configuration is described, a variety of alternative configurations are possible. Processor 601 may perform operations such as those described herein. Instructions for performing such operations may be embodied in memory 603, on one or more non-transitory computer readable media, or on some other storage device. Various specially configured devices can also be used in place of or in addition to processor 601. Memory 603 may be random access memory (RAM) or other dynamic storage devices. Storage device 605 may include a non-transitory computer-readable storage medium holding information, instructions, or some combination thereof, for example instructions that when executed by the processor 601, cause processor 601 to be configured or operable to perform one or more operations of a method as described herein. Bus 615 or other communication components may support communication of information within system 600. The interface 611 may be connected to bus 615 and be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by non-transitory computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Java, Python, C++, C, HTML, any other markup language, JavaScript, ActiveX, VBScript, or Perl. Examples of non-transitory computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A non-transitory computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

Some embodiments may be implemented in a non-transitory computer-readable storage medium for use by or in connection with the instruction execution system, apparatus, system, or machine. The computer-readable storage medium contains instructions for controlling a computer system to perform a method described by some embodiments. The computer system may include one or more computing devices. The instructions, when executed by one or more computer processors, may be configured or operable to perform that which is described in some embodiments.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of some embodiments may be implemented. The above examples and embodiments should not be deemed to be the only embodiments and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

1. A method comprising:
receiving a request for a first asset, the request including a word permutation;
determining whether the first asset can be retrieved from a database using the word permutation;
responsive to determining the first asset cannot be retrieved:
determining a second asset representation for a second asset that is within a threshold to a first asset representation in a space, wherein asset representations are encoded into the space based on contents of respective assets; and
returning the second asset for the request; and
responsive to determining the first asset can be retrieved:
retrieving the first asset from the database; and
returning the first asset for the request.

2. The method of claim 1, wherein the word permutation is a combination of a number of words.

3. The method of claim 1, wherein words in the word permutation are determined from a predetermined set of words.

4. The method of claim 1, further comprising:
using the word permutation to determine an asset identifier for the first asset.

5. The method of claim 4, wherein using the word permutation to determine the asset identifier comprises:
looking up the asset identifier in a data structure, wherein the asset identifier is mapped to information for the word permutation.

6. The method of claim 5, wherein the asset identifier is mapped to a word permutation identifier in the data structure.

7. The method of claim 6, wherein the word permutation identifier is generated based on words in the word permutation and the asset identifier is generated based on content of the first asset.

8. The method of claim 5, wherein the first asset representation is mapped to the asset identifier in the data structure.

9. The method of claim 4, wherein:
the asset identifier is generated using a first algorithm, and
the first asset representation is generated using a second algorithm different from the first algorithm.

10. The method of claim 9, wherein:
the first algorithm generates a hash of the first asset; and
the second algorithm generates an embedding in the space of the first asset.

11. The method of claim 1, wherein determining whether the first asset can be retrieved from the database comprises:
determining whether the first asset is stored in the database.

12. The method of claim 1, wherein:
different systems store different assets in different databases, and
the word permutation is usable to retrieve the first asset from the different databases.

13. The method of claim 1, wherein determining the second asset representation for the second asset that is within the threshold to the first asset representation in the space comprises:
searching the space for asset representations that are within the threshold to the first asset representation; and
selecting a set of asset representations that are within the threshold.

14. The method of claim 13, wherein the second asset representation is selected from the set of asset representations based on a condition.

15. The method of claim 1, wherein storing the first asset comprises:
receiving the first asset for storage in the database;
generating the word permutation for the first asset; and
mapping the word permutation and the first asset representation in a data structure.

16. The method of claim 15, wherein generating the word permutation comprises:
generating the word permutation randomly.

17. The method of claim 15, wherein generating the word permutation comprises:
determining another asset representation that is within a threshold to first asset representation;
determining a word permutation for the another asset representation; and
generating the word permutation for the first asset to be similar to the word permutation for the another asset representation.

18. A non-transitory computer-readable storage medium having stored thereon computer executable instructions, which when executed by a computing device, cause the computing device to be operable for:
receiving a request for a first asset, the request including a word permutation;
using the word permutation to determine an asset identifier for the first asset;
determining whether the first asset can be retrieved from a database using the asset identifier;
responsive to determining the first asset cannot be retrieved:
determining a second asset representation for a second asset that is within a threshold to a first asset representation in a space, wherein asset representations are encoded into the space based on contents of respective assets; and
returning the second asset for the request; and
responsive to determining the first asset can be retrieved:
retrieving the first asset from the database; and
returning the first asset for the request.

19. A method comprising:
receiving a first asset for storage in a database;
determining a first asset representation in a space for the first asset, wherein asset representations are encoded into the space based on contents of respective assets;
determining a second asset representation for a second asset, wherein the second asset representation is within a threshold to first asset representation in the space, and wherein the second asset is stored in the database;
determining a second word permutation for the second asset representation;
generating a first word permutation for the first asset based on the second word permutation for the second asset representation; and
storing the first asset in the database, wherein the first word permutation is usable to retrieve the first asset.

20. The method of claim 19, further comprising:
receiving a request for the first asset, the request including the first word permutation;
determining whether the first asset can be retrieved from the database using the first word permutation;
responsive to determining the first asset cannot be retrieved:
determining the second asset representation for the second asset is within the threshold to the first asset representation in the space; and
returning the second asset for the request; and
responsive to determining the first asset can be retrieved:
retrieving the first asset from the database; and
returning the first asset for the request.
